(19) United States
(12) Patent Application Publication
(10) Pub. No.: US 2007/0129526 A1
(43) Pub. Date: Jun. 7, 2007

(54) Stable liquid, allophanate-modified diphenylmethane diisocyanate trimers, prepolymers thereof, and processes for their preparation

(76) Inventor: William E. Slack, Moundsville, WV (US)

Correspondence Address: BAYER MATERIAL SCIENCE LLC, 100 BAYER ROAD, PITTSBURGH, PA, 15205, US

(21) Appl. No.: 11/654,960

(22) Filed: Jan. 18, 2007

Related U.S. Application Data
(62) Division of application No. 10/706,713, filed on Nov. 12, 2003.

(51) Int. Cl. C08G 18/16

(52) U.S. Cl. 528/48

(57) ABSTRACT

The present invention relates to stable liquid, allophanate-modified, partially trimerized diphenylmethane diisocyanates, the prepolymers of these stable liquid, allophanate-modified, partially trimerized MDI's, and to processes for the preparation of these compositions. These allophanate modified partially trimerized diphenylmethane diisocyanates comprise the reaction product of a diphenylmethane diisocyanate and an organic compound in the presence of a catalytic amount of one or more trimer catalysts, one or more allophanate catalysts, one or more allophanate-trimer catalysts and mixtures thereof. The prepolymers are the reaction product of the stable liquid, allophanate-modified, partially trimerized MDI's with a suitable isocyanate-reactive group containing compound.

### CROSS-REFERENCE TO RELATED APPLICATION

The present application is a divisional application of copending U.S. application Ser. No. 10/706,713, filed on Nov. 12, 2003.

### BACKGROUND OF THE INVENTION

The present invention relates to stable liquid allophanate-modified diphenylmethane diisocyanate trimers, to a process for their preparation, to prepolymers of these stable liquid, allophanate modified diphenylmethane diisocyanates, and to a process for the preparation of the prepolymers.

The trimerization of aromatic isocyanates to form polyisocyanurates is well known in the art. U.S. Pat. Nos. 4,743,627 and 4,382,125 both describe the partial trimerization of polymethylene polyphenylene polyisocyanate (p-MDI), having an average functionality of >2.2, to give stable liquid products having relatively high viscosity at 25° C. (i.e., 2000-100,000 mPa·s).

U.S. Pat. No. 4,284,730 relates to the trimerization of monomeric MDI which has been partially converted to carbodiimide/uretonimine, to give stable liquid polyisocyanurate compositions.

U.S. Pat. No. 5,124,370 describes liquid polyisocyanate mixtures containing isocyanurate groups and having an NCO content of 15 to 30% by weight. These mixtures are obtained by partial trimerization of the isocyanate groups of polyisocyanate mixtures of the diphenylmethane series containing 80 to 100% by weight diisocyanate diphenylmethane isomers and 0 to 20% by weight higher ring compounds of the diphenylmethane series, wherein the monomer consists of 20 to 60% by weight of 2,4′-diphenylmethane diisocyanate, 0 to 8% by weight of 2,2′-diphenylmethane diisocyanate, and 40 to 80% by weight of 4,4′-diphenylmethane diisocyanate.

The trimerization of toluene diisocyanate in a solvent to make a storage stable liquid is described in both U.S. Pat. No. 4,379,905 and DE 19,523,657. These products are disclosed as being suitable as isocyanate components in two-component polyurethane lacquers.

U.S. Pat. No. 4,456,709 describes storage-stable liquid polyisocyanates which have an NCO group content of 36.5 to 45%. These are prepared by mixing 25 to 70 parts of partially trimerized 2,4-TDI with 75 to 30 parts of unmodified 2,4- and/or 2,6-TDI.

U.S. Pat. No. 5,905,151 relates to trimer catalyst systems for aliphatic and aromatic isocyanates. The trimer catalyst systems of this earlier application comprise (A) a lithium compound selected from the group consisting of: (i) lithium salts of aliphatic or aromatic monocarboxylic or dicarboxylic acids, (ii) lithium salts of hydroxyl group containing compounds having from 1 to 3 hydroxyl groups per compound, wherein the hydroxyl groups are directly attached to an aromatic ring, and (iii) lithium hydroxide; and (B) an organic compound containing at least one hydroxyl group. These trimer catalyst systems result in partially trimerized isocyanates which additionally can contain a significant amount of urethane groups.

In accordance with the disclosures of U.S. Pat. No. 4,379,905 and DE 19,523,657, it is necessary that a solvent be present in order to form liquid products. Due to the large quantity of solvent present, these products have restricted uses. In particular, these products are clearly designed for use in coatings applications only.

U.S. Pat. No. 4,456,709 requires pure 2,4-toluene diisocyanate in the first step. The process in this reference results in final products having a relatively narrow NCO content and a restricted distribution of oligomers due to the fact that the trimerization must be completed in the first step of the process.

Another trimer catalyst system is disclosed in U.S. Pat. Nos. 5,955,608 and 6,127,308. This trimer catalyst system is also suitable for both aliphatic and aromatic isocyanates. This system comprises (A) one or more compounds selected from the group consisting of (i) lithium salts of aliphatic or aromatic carboxylic acids, (ii) lithium salts of hydroxyl group containing compounds where the hydroxyl group is attached to an aromatic ring and (iii) lithium hydroxide; (B) an allophanate catalyst; and (C) an organic compound containing at least one hydroxyl group. The partially trimerized isocyanates may also contain allophanate groups and/or urethane groups.

U.S. Pat. Nos. 6,028,158 and 6,063,891 disclose freeze-stable, allophanate-modified toluene diisocyanurates having an NCO group content of about 15 to about 42%. These freeze-stable compositions are prepared by reacting A) toluene diisocyanate, and B) an organic compound containing at least one hydroxyl group, in the presence of a catalytic amount of C) at least one allophanate-trimer catalyst, or an allophanate-trimer catalyst system. These compositions contain both isocyanurate groups and allophanate groups. Also, this patent discloses blends of these allophanate-modified toluene diisocyanurates with polymethylene poly(phenylisocyanates) (i.e., PMDI), wherein the blend has an NCO content of about 16.8 to 41.6%; and urethane prepolymers of these allophanate-modified toluene diisocyanurates, as well as the blends of these with PMDI, which have NCO group contents of from about 14 to about 40%.

U.S. Pat. No. 4,518,761 discloses a process for the preparation of mixed trimers by at least partially trimerizing the isocyanate groups of two isocyanate components with different reactivities (with respect to trimerization) in the presence of a trimerization catalyst, and mixed trimers prepared by this process. The process comprises (a) adding a less reactive isocyanate component to a vessel, (b) trimerizing at least about 0.1% of the isocyanate groups of the less reactive isocyanate component in the presence of a trimerization catalyst, (c) metering the more reactive isocyanate component into the reaction vessel, and optionally, (d) terminating the trimerization reaction at the desired degree of trimerization by thermal decomposition of the trimer catalyst and/or adding a catalyst stopper/poison. This process requires the two isocyanate components to have different reactivities. Thus, one isocyanate may have aliphatically and/or cycloaliphatically bound isocyanate groups and the other isocyanate may have aromatically bound isocyanate groups; or one isocyanate may have aliphatically or cycloaliphatically bound isocyanate groups and the other isocyanate may have heteroaromatically bound isocyanates groups; etc. This approach allows for the incorporation of an aromatic isocyanate into a trimer product that may be a liquid. U.S. Pat. No. 4,518,761 does not disclose or suggest how to make liquid trimer products from aromatic isocyanate components.

U.S. Pat. No. 4,772,639 relates to a process for the production of molded polyurethane and also discloses polyisocyanate mixtures that contain trimer groups. These isocyanates are either (1) mixtures of (i) isophorone diisocyanate and (ii) a polyisocyanate containing isocyanurate groups based on 1,6-diisocyanato-hexane; or (2) mixtures of (i) isophorone diisocyanate and (ii) a polyisocyanate containing isocyanurate groups based on 1,6-diisocyanato-hexane and isophorone diisocyanate.

U.S. Pat. No. 5,798,431 describes a process for the production of polyisocyanates containing isocyanurate groups by catalytically trimerizing a mixture of a) a low molecular weight isocyanate component having aliphatically bound isocyanate groups, an average molecular weight of 128 to 800 and an average NCO functionality of 1.7 to 2.2, and b) a low molecular weight isocyanate component having an aromatically bound isocyanate group, an average molecular weight of 148 to 800 and an average NCO functionality of 1.7 to 2.2, in the presence of c) an aminosilyl compound. Any excess distillable isocyanate is subsequently removed to form a polyisocyanate having a monomer content of less than 0.7%, based on the weight of polyisocyanate solids. The examples are directed to toluene diisocyanate and hexamethylene diisocyanate.

A process for the preparation of a polyurea resin is disclosed by U.S. Pat. No. 5,319,058. It comprises (A) mixing (a) an aromatic polyamine component which comprises a combination of at least two aromatic polyamine compounds corresponding to specified formulas and (b) an aliphatic polyisocyanate to form a mixture, and (B) heating the mixture to effect the reaction between the amino groups and the isocyanato groups. Suitable polyisocyanates for component (b) comprise (b1) an aliphatic diisocyanate, and (b2) a cyclic trimer of an aliphatic polyisocyanate.

U.S. Pat. No. 5,102,918 describes a process for producing a modified organic polyisocyanate having an isocyanurate ring. This process comprises adding a trimerization catalyst, an organic phosphite ester and a surfactant (and optionally a ferrocene compound) to an organic polyisocyanate and/or a partially urethanized organic polyisocyanate to form isocyanurate groups of not more than 20% of the total of isocyanate groups. A stopper is added, if necessary. Suitable organic polyisocyanates include both TDI and MDI. Example 18 appears to use MDI and TDI.

U.S. Pat. No. 4,255,659 discloses that isocyanates of differing reactivities are suitable for the process described therein (see column 2, lines 16-23). These include mixtures of TDI and IPDI, and appears to be similar to the '761 patent discussed above.

Carbodiimide and/or uretonimine-isocyanurate-containing polyisocyanates are described by U.S. Pat. No. 4,284,730. These can be prepared by (a) partial trimerization of a mixture of a polyisocyanate and a polyisocyanate-uretonimine with trimer catalysts to the desired free isocyanate level, (b) sequential partial carbodiimidization to uretonimine followed by partial trimerization of a polyisocyanate, (c) sequential trimerization of the polyisocyanate followed by partial carbodiimidization, (d) simultaneous conversion using a mixed catalyst system of carbodiimide and isocyanurate catalysts, (e) blending liquid polyisocyanate with a polyisocyanate-uretonimine mixture and a polyisocyanate-isocyanurate mixture (see column 2, lines 37-50).

U.S. Pat. Nos. 4,326,043, 4,359,541 and 4,359,550 each describes dispersible polyisocyanurate polymers. Suitable isocyanates are disclosed broadly, including mixtures of TDI, MDI and PMDI. This reference also discloses that the isocyanate can be converted to a trimer in a solvent which is a solid, and then dispersed in a polyol. Examples 48-84 of the '043 patent disclose the dispersed trimer solid containing catalysts, surfactants, etc., is reacted with the isocyanate blend of TDI/MDI (80:20) to form a foam.

Stable solutions of trimerized isocyanate prepolymers in monomeric polyisocyanates are described by the U.S. Pat. No. 4,552,902. First an isocyanate-terminated prepolymer is made, then a cotrimer is formed by trimerizing the NCO-terminated prepolymer with MDI or PMDI. The cotrimer is reacted with an excess of a low equivalent weight polyol to form another isocyanate-terminated prepolymer. TDI is suitable for forming the first NCO-terminated prepolymer. The examples all use TDI and MDI, and various polyols to form the prepolymers. It is expressly stated at column 5, lines 50-55, that the diols must be present for the products to be liquids. Also, the first step of making a prepolymer followed by the addition of the second isocyanate, then trimerizing the mixture will result in allophanate formation.

GB 1,337,659 describes a polyisocyanate solution which comprises a solution of at least one polyisocyanate containing at least one isocyanuric acid ring dissolved in a monomeric polyisocyanate which is free from isocyanurate groups. These are not mixed trimers, but rather are a TDI trimer mixed with a TDI prepolymer. Only Example 5 describes the preparation of a mixed trimer product from MDI and TDI with 1,2-propylene glycol. However, this product contains less than 3% by weight of trimer, and there is no evidence that it would be a stable liquid product. None of the final isocyanate products in these working examples are pure mixed trimers. Rather, each of these products contains some urethane and/or allophanate groups, and contains a relatively small quantity of trimer groups. Allophanate modifications tend to form liquid products. Therefore, these products would be expected to be liquids.

Advantages of the presently claimed storage stable, allophanate-modified diphenylmethane diisocyanate trimers include the presence of a reduced amount of the 2,4′-isomer of diphenylmethane diisocyanate which improves the reactivity, cure and physical properties of the resultant polyurethane products prepared with these stable trimers.

### SUMMARY OF THE INVENTION

This invention relates to stable liquid, allophanate-modified, partially trimerized diphenylmethane diisocyanates having an NCO group content of from about 15 to 30% by weight, preferably from 20 to 28% by weight. These are the reaction product of:

a)(1) a diphenylmethane diisocyanate component having

(i) from 10 to 40%, preferably from 20 to 35%, by weight of 2,4′-diphenylmethane diisocyanate,
(ii) from 0 to 6%, preferably from 0 to 2%, by weight of 2,2′-diphenylmethane diisocyanate,
and
(iii) from 54 to 90%, preferably from 63 to 80%, by weight of 4,4′-diphenylmethane diisocyanate,
wherein the %'s by weight of a)(1)(i), a)(1)(ii) and a)(1)(iii) total 100% by weight of a)(1);
   and
   b) an organic compound which contains at least one hydroxyl group,
   in the presence of a catalytic amount of:
   c) at least one catalyst selected from the group consisting of
(1) one or more trimer catalysts,
(2) one or more allophanate catalysts,
(3) an allophanate-trimer catalyst system,
and
(4) mixtures thereof.

There are from about 0.01 to about 0.25 equivalent hydroxyl groups from component b) present per equivalent of isocyanate of the MDI present, and at least about 50% of the urethane groups are converted to, allophanate groups by c) the catalyst. Preferably there are from about 0.01 to about 0.20 equivalent hydroxyl groups per equivalent of isocyanate, and at least about 70%, more preferably at least about 80%, most preferably at least about 90% and most particularly preferably at least about 95% of urethane groups are converted to allophanate groups. A catalyst stopper is added once the desired NCO group content is attained.

The present invention also relates to a process for preparing these stable liquid, allophanate-modified, partially trimerized diphenylmethane diisocyanates. In this process, the product is prepared by

(I) heating

a)(1) the diphenylmethane diisocyanate which contains
   (i) from 10 to 40%, preferably from 20 to 35%, by weight of 2,4′-diphenylmethane diisocyanate,
   (ii) from 0 to 6%, preferably from 0 to 2%, by weight of 2,2′-diphenylmethane diisocyanate,
   and
   (iii) from 54 to 90%, preferably from 63 to 80%, by weight of 4,4′-diphenylmethane diisocyanate,
   wherein the %'s by weight of a)(1)(i), a)(1)(ii) and a)(1)(iii) total 100% by weight of a)(1);
and
b) an organic compound containing at least one hydroxyl group, to a temperature of from about 70 to about 120° C., preferably 85 to 95° C., for a period of about 1 to about 6 hours, in the presence of a catalytic amount of
c) at least one catalyst selected from the group consisting of:
   (1) one or more trimer catalysts,
   (2) one or more allophanate catalyst,
   (3) an allophanate-trimer catalyst system,
   and
   (4) mixtures thereof.

The quantity of b) is such that there is from about 0.01 to 0.25 equivalent hydroxyl groups per equivalent of isocyanate in a), and at least about 50% of the urethane groups are converted to allophanate groups by the catalyst(s). Preferably there are from about 0.01 to about 0.20 equivalent hydroxyl groups per equivalent of isocyanate, and at least about 70%, more preferably at least about 80%, most preferably at least about 90% and most particularly preferably at least about 95% of urethane groups are converted to allophanate groups. The heating is followed by (2) adding a catalyst stopper once the desired NCO group content is attained to neutralize the catalyst in the reaction mixture.

The stable liquid, allophanate-modified, partially trimerized diphenyl-methane diisocyanates having an NCO group content of from 15 to 30% by weight, preferably from 20 to 28% by weight, may also be a blend of:
(A) from 20 to 65% by weight, based on 100% by weight of (A) and (B), of an allophanate-modified diphenylmethane diisocyanate having an NCO group content of from about 16 to about 29%, and is the reaction product of:
   a)(2) a diphenylmethane diisocyanate having:
      (i) from 0 to 60% by weight of 2,4′-diphenylmethane diisocyanate,
      (ii) from 0 to 6% by weight of 2,2′-diphenylmethane diisocyanate,
      and
      (iii) from 34 to 100% by weight of 4,4′-diphenylmethane diisocyanate,
      wherein the %'s by weight of a)(2)(i), a)(2)(ii) and a)(2)(iii) total 100% by weight of a)(2),
   and
   b) an organic compound containing at least one hydroxyl group,
   in the presence of:
   c) at least one allophanate catalyst,
   wherein component b) is present in a quantity such that there are from about 0.05 to about 0.25 equivalent hydroxyl groups per equivalent of isocyanate of the MDI present, at least about 50% of the urethane groups are converted to allophanate groups by c), and a catalyst stopper is added once the desired NCO group content of the allophanate-modified MDI is attained;
and
(B) from 35% to 80% by weight, based on 100% by weight of (A) and (B), of an at least partially trimerized diphenylmethane diisocyanate having an NCO group content of from about 20 to about 31, and is the trimerization product of:
   a)(3) a diphenylmethane diisocyanate having:
      (i) from 10 to 60% by weight of 2,4′-diphenylmethane diisocyanate,
      (ii) from 0 to 6% by weight of 2,2′-diphenylmethane diisocyanate,
   and
      (iii) from 34 to 90% by weight of 4,4′-diphenylmethane diisocyanate,
   wherein the %'s by weight of a)(3)(i), a)(3)(ii) and a)(3)(iii) total 100% by weight of a)(3),
   in the presence of
   b) at least one catalyst selected from the group consisting of:
      (1) at least one trimer catalyst,
      (3) an allophanate-trimer catalyst system,
      and
      (4) mixtures thereof,
   wherein the trimer content is at least about 10 to about 80% by weight, based on 100% by weight of component (B).

The process for preparing these stable, liquid allophanate-modified, partially trimerized diphenylmethane diisocyanates having an NCO group content of from 15 to 30%, are prepared by: (1) blending (A) an allophanate-modified diphenylmethane diisocyanate having an NCO group content of about 16 to about 29% and which is the reaction product of a)(2) MDI and b) an organic compound containing at least one hydroxyl group in the presence of c)(2) one or more allophanate catalysts, wherein a catalyst stopper has been added once the desired NCO group content of the allophanate-modified diphenylmethane diisocyanate is attained; with (B) an at least partially trimerized diphenylmethane diisocyanate having an NCO group content of from about 20 to about 31%, and which is the trimerization product of a)(3) MDI formed in the presence of c)(1) a trimer catalyst, c)(3) an allophanate-trimer catalyst system, or mixtures thereof, wherein a catalyst stopper has been added once the desired NCO group content of the trimer product is attained; and (2) cooling the blend to ambient temperature. The isomer distribution for MDI a)(2) which is used in the preparation of the allophanate-modified MDI differs slightly from the isomer distribution as set forth above for MDI a)(1). The isomer distribution for MDI a)(3) which is used in the preparation of the trimerized MDI differs slightly from the isomer distribution as set forth above for MDI a)(1) and from the isomer distribution for MDI a)(2).

Another aspect of the present invention relates to prepolymers of the allophanate-modified, partially trimerized diphenylmethane diisocyanates. These prepolymers are also storage stable liquids as defined herein. These prepolymers have NCO group contents of from about 8 to about 28%, and comprise the reaction product of the allophanate-modified, partially trimerized diphenylmethane diisocyanates having an NCO group content of from 15 to 30% by weight, with an isocyanate-reactive component which contains from about 1.5 to about 6 hydroxyl groups and having a molecular weight of from about 76 to about 10,000. The allophanate-modified, partially trimerized diphenylmethane diisocyanates may either be prepared simultaneously, the allophanate prepared first and then the trimer, or the allophanate and the trimer may be prepared separately and blended together.

The process of preparing the urethane prepolymers of the allophanate-modified, partially trimerized diphenylmethane diisocyanates comprises reacting the storage stable liquid allophanate-modified, partially trimerized diphenylmethane with a suitable isocyanate-reactive component as described above. As above, the allophanate-modified, partially trimerized diphenylmethane diisocyanates used herein may be prepared in any suitable manner.

### DETAILED DESCRIPTION OF THE INVENTION

In accordance with the present invention, the term “liquid” means that the partially trimerized allophanate-modified product does not precipitate solids when stored at 25° C. for 3 months; and the term “storage-stable” means that the partially trimerized, allophanate-modified product has up to a 1% absolute change in the % NCO group content and up to a 10% change in the viscosity when stored at 25° C. for 3 months.

In the stable liquid, allophanate-modified, partially trimerized diphenyl-methane diisocyanates of the present invention and the process(es) for making them, the following components are, generally speaking, suitable.

Suitable diphenylmethane diisocyanates to be used as component a) in the allophanate-modified, partially trimerized diisocyanates of the present invention include those diphenylmethane diisocyanates having NCO group contents of about 33.0% to about 33.6%, preferably about 33.4% to about 33.6%, and most preferably about 33.6%.

The suitable diphenylmethane diisocyanates a)(1) comprise (i) from 10 to 40% by weight of 2,4′-diphenylmethane diisocyanate, (ii) from 0 to 6% by weight of 2,2′-diphenylmethane diisocyanate, and (iii) from 54 to 90% by weight of 4,4′-diphenylmethane diisocyanate, with the %'s by weight of a)(1)(i), a)(1)(ii) and a)(1)(iii) totaling 100% by weight of a)(1). The % by weight of a)(1)(i) the 2,4′-isomer of diphenylmethane diisocyanate is typically at least about 10%, and preferably at least about 20%. The % by weight of (i) the 2,4′-isomer generally is about 40% or less, and preferably about 35% or less. The diphenylmethane diisocyanate component a)(1) may have (i) a 2,4′-isomer content ranging between any of these upper and lower values, inclusive, e.g., from 10 to 40%, and preferably from 20 to 35%. The % by weight of the (ii) 2,2′-isomer of diphenylmethane diisocyanate is typically about 0% or more. The % by weight of (ii) the 2,2′-isomer generally is about 6% or less, and preferably about 2% or less. The diphenylmethane diisocyanate component a)(1) may have (ii) a 2,2′-isomer content ranging between any of these upper and lower values, inclusive, e.g., from about 0 to about 6%, and preferably from about 0 to about 2%. The % by weight of (iii) the 4,4′-isomer of diphenylmethane diisocyanate is typically at least about 54%, and preferably at least about 63%. The % by weight of (iii) the 4,4′-isomer generally is about 90% or less, and preferably of about 80% or less. The diphenylmethane diisocyanate component a)(1) may have (iii) a 4,4′-isomer content ranging between any of these upper and lower values, inclusive, e.g., from 54 to 90%, and preferably from 63 to 80%. The amounts of (i), (ii) and (iii) always total 100% by weight of a)(1) the diphenylmethane diisocyanate.

Some examples of preferred isocyanates include isomeric mixtures of diphenylmethane diisocyanate a)(1) containing from about 20 to 35% of the 2,4′-isomer, from about 0 to about 2% of the 2,2′-isomer and from about 63 to about 80% of the 4,4′-isomer (with the %'s by weight of the isomers totaling 100%).

Organic compounds containing at least one hydroxyl group b) are necessary according to the presently claimed invention. Suitable compounds typically include those compounds having a (number average) molecular weight of at least about 32, preferably of at least about 60, and most preferably of at least about 74. These organic compounds containing at least one hydroxyl group also typically have a (number average) molecular weight of about 6,000 or less, preferably of about 4,800 or less, more preferably of about 3,000 or less and most preferably of about 1,000 or less. The organic compound may have a (number average) molecular weight ranging between any combination of these upper and lower values, inclusive, e.g., from about 32 to about 6,000, preferably from about 60 to about 4,800, more preferably from about 74 to about 3,000 and most preferably from about 74 to about 1,000.

Suitable compounds for component b) of the present invention also typically include those compounds containing at least about 1 hydroxyl group. These organic compounds also typically contain about 4 hydroxyl groups or less, preferably about 3 hydroxyl groups or less, and most preferably about 2 hydroxyl groups or less. The organic compound may contain any number of hydroxyl groups ranging between any combination of these upper and lower values, inclusive, e.g., from about 1 to about 4, preferably from about 1 to about 3, and most preferably from about 1 to about 2.

It is preferred that these organic compounds containing at least one hydroxyl group are lower molecular weight organic compounds containing from 1 to 4, more preferably 1 to 3 hydroxyl groups and most preferably 1 to 2 hydroxyl groups, and having a molecular weight range of from 32 to about 400. Suitable organic compounds include, for example, methanol, ethanol, 1,2-ethanediol, 1-propanol, 2-propanol, 1-butanol, isobutyl alcohol, 2-butanol, n-amyl alcohol, sec-amyl alcohol, tert-amyl alcohol, 1-ethyl-1-propanol, n-hexanol and isomers thereof, n-octyl alcohol, 2-octyl alcohol, 2-ethyl-1-hexanol, n-decyl alcohol, n-dodecyl alcohol, neopentylglycol, n-tetradecyl alcohol, n-hexadecyl alcohol, n-octadecyl alcohol, 1,3-propanediol, 1,4-butanediol, 1,3-butanediol, 2,3-butanediol, 3-methyl-2-butanol, 3,3-dimethyl-1-butanol, 2-ethyl-1,3-hexanediol, glycerol, 1,2,4-butanetriol, pentaerythritol, diethylene glycol, dipropylene glycol, diethylene glycol, triethylene glycol, etc. It is more preferred for these organic compounds to contain from 1 to 2 hydroxyl groups, such as a monoalcohol or a diol, and have a molecular weight of from 60 to about 200. Examples include 1-propanol, 2-propanol, 1-butanol, 2-butanol, n-amyl alcohol, 1-methylbutyl alcohol, 1-ethyl-1-propanol, n-octyl alcohol, 2-octyl alcohol, 2-ethyl-1-hexanol, neopentyl-glycol, 1,2-propanediol, 1,3-propanediol, 1,4-butanediol, 1,3-butanediol, 2,3-butanediol, 2-ethyl-1,3-hexanediol, diethylene glycol, triethylene glycol, dipropylene glycol, tripropylene glycol, etc. Preferred compounds are isomeric alcohols having between 2 and 16 carbon atoms such as, for example, the isomeric butanols, and the isomeric propanols. Most preferred are 2-propanol and isobutyl alcohol.

In addition to the lower molecular weight organic compounds containing at least one hydroxyl group identified above, higher molecular weight adducts of these low molecular weight compounds are also suitable to be used as component b) of the present invention. These relatively high molecular weight polyether polyols include those conventionally used in polyurethane chemistry, and can be prepared by the epoxidation of a low molecular weight organic compound in the presence of a suitable catalyst to yield a higher molecular weight adduct. Suitable polyether polyols typically have molecular weights in the range of from greater than 400 to about 6,000, preferably about 500 to about 3,000, more preferably about 500 to about 2,000. It is preferred that these polyether polyols have a functionality of 1 to 3.

Suitable polyethers are known and may be prepared, for example, by the polymerization of epoxides, optionally in the presence of a catalyst such as BF₃, or by chemical addition of such epoxides, optionally as mixtures or successively, to starting components containing reactive hydrogen atoms. Suitable epoxides include ethylene oxide, propylene oxide, butylene oxide, tetrahydrofuran, styrene oxide, or epichlorohydrin. Suitable starter components include water, alcohols, or amines, including, for example, ethylene glycol, 1,2- or 1,3-propanediol, 1,2-, 1,3-, or 1,4-butanediol, trimethylolpropane, 4,4′-dihydroxydiphenylpropane, aniline, glycerine, ammonia and ethanolamine. Polyethers that contain predominantly primary hydroxyl groups (up to about 90% by weight, based on all of the hydroxyl groups in the polyether) are also often preferred. Also suitable are polybutadienes containing hydroxyl groups, and polyalkylene polyethers, such as polyoxyethylene diol, polyoxypropylene diol, polyoxybutylene diol, and polytetramethylene diol.

It is, of course, also possible to use a mixture of one or more of the relatively high molecular weight organic compounds containing at least one hydroxyl group, with one or more of the relatively low molecular weight organic compounds containing at least one hydroxyl group.

In accordance with the present invention, b) the organic compound containing at least one hydroxyl group is typically present in a quantity such that there are from about 0.01 to about 0.25 equivalent hydroxyl group per equivalent of diphenylmethane diisocyanate a)(1) present. It is preferred that there are from about 0.01 to about 0.2, more preferably about 0.03 to about 0.18, most preferably about 0.05 to about 0.15 and most particularly preferably about 0.07 to about 0.12 equivalent hydroxyl group per equivalent of diphenylmethane diisocyanate a)(1) present. Also, there should be at least about 50%, preferably at least about 70%, more preferably at least about 80% of the equivalents of hydroxyl groups present in b) the organic compound which contains hydroxyl groups which are converted from urethane groups to allophanate groups in the final product. Most preferably, at least about 90% (and most particularly preferably 95%) of the equivalents of hydroxyl groups present in b) the organic compound which contains hydroxyl groups are converted from urethane groups to allophanate groups.

In accordance with the present invention, a catalyst is required to form stable liquid, allophanate-modified, at least partially trimerized diphenyl-methane diisocyanates. Suitable catalysts to be used as component c) in accordance with the present invention are selected from the group consisting of (1) one or more trimer catalysts, (2) one or more allophanate catalysts, (3) an allophanate-trimer catalyst system and (4) mixtures thereof. Typically, depending on the specific catalyst(s) used, the present invention requires a combination of one or more trimer catalysts and one or more allophanate catalysts; one or more trimer catalysts provided that at least one trimer catalyst is present which acts or functions to promote both trimer formation and allophanate formation (i.e., one or more allophanate-trimer catalysts; or an allophanate-trimer catalyst system). These are described below in more detail for convenience, although this detail is not intended to be limiting. Generally speaking, the quantity of catalysts used is such that there are from about 100 to about 500 ppm of trimer catalyst and/or trimer-allophanate catalyst present, and from about 24 to about 200 ppm of allophanate catalyst present. The weight of catalyst present is based on the total combined weight of components a)(1) and b).

Suitable trimer catalysts to be used as component (1) in the catalysts of the present invention include, for example, any of the known trimerization catalysts which convert at least about 50%, preferably at least about 70%, more preferably at least about 80%, most preferably at least about 90% and most particularly preferably at least about 95% of the equivalents of the urethane groups formed to allophanate groups. Some examples of trimer catalysts include alkali carboxylates as described in U.S. Pat. No. 4,604,418, the disclosure of which is herein incorporated by reference; basic alkali metal salts complexed with acyclic organic compounds as described in U.S. Pat. No. 4,379,905, the disclosure of which is herein incorporated by reference; basic alkali metal salts complexed with crown ethers as described in U.S. Pat. No. 4,487,928, the disclosure of which is herein incorporated by reference; combinations of tertiary amines with specific quaternary ammonium salts as described in U.S. Pat. No. 3,954,684, the disclosure of which is herein incorporated by reference; and alkali metals salts or quaternary ammonium salts of carboxylic acids which correspond to one of several different structures as described in U.S. Pat. Nos. 4,632,785 and 4,540,781, the disclosures of which are herein incorporated by reference; various lithium salts of monocarboxylic acids, lithium salts of hydroxyl group containing compounds and lithium hydroxide, in combination with an organic compound having at least one hydroxyl group as described in, for example, U.S. Pat. No. 5,905,151; etc. Other known trimer catalysts include, for example, catalyst which inherently form both trimer groups and allophanate groups. Among these trimer catalysts are included the Mannich bases such as, for example, 2,4,6-bis(dimethyl-aminomethyl)phenol; and metal salts of carboxylic acids such as, for example, lead octanoate and potassium acetate.

Generally speaking, most known trimer catalysts also result in allophanate formation. Thus, depending on the embodiment of the present invention, it may be sufficient to select a trimer catalyst to promote formation of both trimer and allophanate groups. A trimer catalyst alone may be sufficient for all aspects of the present invention, except when the allophanate and trimer are prepared separately and blended together. In this particular aspect of the present invention, an allophanate catalyst is needed to promote the formation of the allophanate-modified diphenylmethane diisocyanate.

Some examples of suitable allophanate catalysts to be used as component (2) in the catalysts of the present invention include, for example, metal carboxylates and metal acetylacetonates. Some examples of suitable allophanate catalysts for the present invention include zinc octoate, tin-2-ethylhexanoate, zinc acetyl-acetonate, zinc-2-ethylhexanoate, cobalt linoresinate, lead naphthenate, lead 2-ethylhexanoate, lead linoresinate, cobalt 2-ethylhexanoate, cobalt naphthenate, etc. Preferred allophanate catalysts are zinc octoate, tin octoate, zinc-2-ethylhexanoate, tin-2-ethylhexanoate, and zinc acetylacetonate.

Suitable examples of allophanate-trimer catalyst systems to be used as c)(3) in the present invention include those systems which comprise (a) at least one catalyst capable of forming trimer groups, and (b) at least one catalyst capable of forming allophanate groups. Such trimer catalysts and allophanate catalysts are known by those of ordinary skill in the art. In accordance with the present invention, suitable catalyst systems are those which convert at least 50%, preferably at least about 70%, more preferably at least about 80%, most preferably at least about 90%, and most particularly preferably at least about 95% of equivalents of the urethane groups to allophanate groups.

A preferred allophanate-trimer catalyst system c)(3) for the present invention comprises:

(i) at least one trimer catalyst selected from the group consisting of:

(a) lithium salts of aliphatic or aromatic monocarboxylic acids or dicarboxylic acids,
(b) lithium salts of hydroxyl group containing compounds containing from 1 to 3 hydroxyl groups per compound, wherein the hydroxyl groups are attached directly to an aromatic ring,
(c) lithium hydroxide,
and
(d) mixtures thereof;
   and
   (ii) at least one allophanate catalyst.

Suitable allophanate-trimer catalyst systems for component c)(3) of the present invention includes, for example, those as described in U.S. Pat. Nos. 5,955,609 and 6,127,308, the disclosures of which are herein incorporated by reference.

When using the preferred allophanate-trimer catalyst system in the present invention, the molar ratio of allophanate catalyst, c)(3)(ii), to lithium compound, c)(3)(i), is from 20:1 to 1:20. Based on this, it is preferred to use between 1×10⁻⁶ to 4×10⁻⁵ mole of allophanate catalyst, c)(3)(ii), in conjunction with 0.015 to 0.2 equivalent hydroxyl groups from the organic compound which contains at least one hydroxyl group, i.e. component b), per equivalent of isocyanate of a) the diphenylmethane diisocyanate present to be trimerized. It is most preferred to use from about 5×10⁻⁶ to 3.2×10⁻⁵ mole of allophanate catalyst, c)(3)(ii), with the appropriate amount of lithium compound, c)(3)(i), as described above, and from about 0.01 to about 0.20, preferably about 0.03 to about 0.18 equivalent hydroxyl group of the organic compound containing at least one hydroxyl group b), per equivalent of isocyanate of the MDI to be trimerized.

Suitable catalyst stoppers for use in accordance with the present invention include, for example, acidic catalyst stoppers such as, for example, anhydrous hydrochloric acid, sulfuric acid, bis(2-ethylhexyl) hydrogen phosphate, benzoyl chloride, Lewis Acids and the like. Preferred catalyst stoppers are benzoyl chloride and bis(2-ethylhexyl) hydrogen phosphate. The quantity of stopper used is the amount needed to deactivate the catalysts. This will vary depending on the catalyst and stopper used. In general, however, between 50 and 100% by wt. of stopper relative to the weight of the catalyst is typically needed.

The preparation of the stable-liquid, allophanate-modified, partially trimerized diphenylmethane diisocyanates of the present invention can be done by several different methods or processes. One process simultaneously forms the allophanate-modified, partially trimerized MDI product which is a stable liquid, and another forms an allophanate-modified MDI first, and then partially trimerizes some of the remaining NCO groups. In another process, the allophanate-modified MDI and the trimerized MDI are formed separately as individual products, and then these two products are blended together to form the allophanate-modified MDI trimers. More detailed information concerning these processes is set forth below.

In the case where the allophanate and trimer are simultaneously prepared, the hydroxyl compound is added to the MDI at temperatures between 40 and 80° C. The addition of either an allophanate/trimer catalyst, or of an allophanate catalyst and a trimer catalyst can occur before, during or after the addition of the hydroxyl compound. After the desired NCO group content is reached at 70 to 120° C., an acidic stopper is added and the product is cooled to about 25° C. for storage.

In the case where the allophanate is prepared first, the allophanate catalyst can be added before, during or after the hydroxyl compound is added to the MDI. The urethane is then converted to the allophanate modified MDI at temperatures between 70 and 120° C., before the addition of the trimer catalyst. The trimer catalyst is then added, and the reaction mixture is held at a temperature between 70 and 120° C. until the desired NCO group content is reached at which time the acidic stopper is added. Then, the product is cooled to about 25° C. for storage.

In the embodiment of the present invention wherein the stable liquid, allophanate-modified, at least partially trimerized diphenylmethane diisocyanates having an NCO group content of from 15 to 30%, preferably of from 20 to 28%, and most preferably of from 22 to 26%, are blends of: (A) an allophanate-modified MDI having an NCO group content of 16 to 29%; and (B) a partially trimerized MDI having an NCO group content of 20 to 31%.

These blends comprise:
(A) from 20 to 65% (preferably 30 to 60%, most preferably 35 to 55%) by weight, based on 100% by weight of (A) and (B), of an allophanate-modified diphenylmethane diisocyanate having an NCO group content of about 16 to about 29%, preferably about 20 to about 28%, and most preferably about 21 to about 26%;
and
(B) from 35 to 80% (preferably 40 to 70%, most preferably 45 to 65%) by weight, based on 100% by weight of (A) and (B), of an at least partially trimerized diphenylmethane diisocyanate having an NCO group content of about 20 to about 31%, preferably about 22 to about 29%, and most preferably about 24 to about 27%.

In these blends, component (A), the allophanate-modified diphenylmethane diisocyanate, comprises the reaction product of:
a)(2) a diphenylmethane diisocyanate comprising:
   (i) from 0 to 60% (preferably 10 to 50%, most preferably 20 to 40%) by weight of 2,4′-diphenylmethane diisocyanate,
   (ii) from 0 to 6% (preferably 0 to 4%, most preferably 0 to 2%) by weight of 2,2′-diphenylmethane diisocyanate,
   and
   (iii) from 34 to 100% (preferably 50 to 90%, most preferably 60 to 80%) by weight of 4,4′-diphenylmethane diisocyanate,
   wherein the %'s by weight of a)(2)(i), a)(2)(ii) and a)(2)(iii) totals 100% by weight of a)(2);
and
b) an organic compound containing at least one hydroxyl group,
in the presence of
c) (2) at least one allophanate catalyst.

In the allophanate-modified diphenylmethane diisocyanates to be used as component (A) in the above blends, suitable organic compounds containing at least one hydroxyl group to be used as component b) and suitable allophanate catalysts to be used as component c)(2) are as described previously above. The quantity of component b) present is such that there are from about 0.05 to 0.25 equivalent hydroxyl groups per equivalent of isocyanate of the MDI present, and preferably about 0.1 to 0.2 equivalent hydroxyl groups per equivalent of isocyanate of the MDI present. In addition, at least about 50% of the urethane groups are converted to allophanate groups by the catalyst. Preferably about 70%, more preferably about 80%, most preferably about 90% and most particularly preferably about 95% of the urethane groups are converted to allophanate groups.

Suitable diphenylmethane diisocyanates to be used to form the allophanate-modified MDI above have NCO group contents of about 33.0% to about 33.6%, preferably about 33.4% to about 33.6%, and most preferably about 33.6%, and have an isomer distribution as described above for component a)(2).

In the partially trimerized diphenylmethane diisocyanates to be used as component (B) in the above blends, these are the trimerization products of MDI in the presence of a trimer catalyst. More specifically, these are the trimerization products of:
a)(3) a diphenylmethane diisocyanate comprising:
   (i) from 10 to 60% (preferably 15 to 50%, most preferably 20 to 40%) by weight of 2,4′-diphenylmethane diisocyanate,
   (ii) from 0 to 6% (preferably 0 to 4%, most preferably 0 to 2%) by weight of 2,2′-diphenylmethane diisocyanate,
   and
   (iii) from 34 to 90% (preferably 50 to 85%, most preferably 60 to 80%) by weight of 4,4′-diphenylmethane diisocyanate,
   wherein the %'s by weight of a)(3)(i), a)(3)(ii) and a)(3)(iii) totals 100% by weight of a)(3);
in the presence of
c)(1) at least one trimer catalyst,
   wherein the trimer content is at least about 10 to about 80%, preferably about 25 to about 60% and most preferably about 30 to about 40%, based on 100% by weight of component (B).

The diphenylmethane diisocyanates suitable for preparing the trimerized diphenylmethane diisocyanate include those having an NCO group content of about 33.0% to about 33.6%, preferably about 33.4% to about 33.6% and most preferably about 33.6%, and having an isomer distribution as described above for component a)(3). Suitable trimer catalysts for this aspect of the invention include those trimer catalysts c)(1) as described hereinabove for the product prepared either with simultaneous formation of allophanate groups and trimer groups, or allophanate groups being formed first and then trimer groups being formed.

In the urethane prepolymers from the stable-liquid, allophanate-modified, at least partially trimerized diphenylmethane diisocyanates of the present invention and the corresponding processes of preparing these, suitable isocyanate-reactive compounds for the present application wherein urethane prepolymers of the stable-liquid allophanate modified, partially trimerized diphenylmethane diisocyanates are prepared by reacting the allophanate-modified, partially trimerized MDI with, for example, (II) an isocyanate-reactive component containing from about 1.5 to about 6 hydroxyl groups capable of reacting with NCO groups, and having molecular weights of from about 76 up to about 10,000. Such compounds include, for example, polyether polyols, polyester polyols, and diols.

These isocyanate-reactive components include those compounds which typically have at least 1.5 hydroxyl groups that are capable of reacting with NCO groups, and preferably at least 1.8 hydroxyl groups and more preferably at least 2 hydroxyl groups. These isocyanate-reactive components also typically have less than or equal to 6 hydroxyl groups, preferably less than or equal to 5 hydroxyl groups, more preferably less than or equal to 4 hydroxyl groups and most preferably less than or equal to 3 hydroxyl groups. The isocyanate-reactive components may also have a number of hydroxyl groups ranging between any combination of these upper and lower values, inclusive, e.g., from 1.5 to 6 hydroxyl groups, preferably from 1.8 to 6 hydroxyl groups, more preferably from 2 to 4 hydroxyl groups and most preferably from 2 to 3 hydroxyl groups.

In addition, these isocyanate-reactive components typically have a molecular weight of at least about 76, preferably at least about 90, more preferably at least about 192 and most preferably at least about 400. Typically, the isocyanate-reactive components also have a molecular weight of less than or equal to about 10,000, preferably less than or equal to 6,000, more preferably less than or equal to about 4,800 and most preferably less than or equal to about 4,000. The isocyanate-reactive components may also have a molecular weight ranging between any combination of these upper and lower values, inclusive, e.g., from 76 to 10,000, preferably from 90 to 6,000, more preferably from 192 to 4,800 and most preferably from 400 to 4,000.

Polyether polyols suitable as isocyanate-reactive compounds (II) for this aspect of the present invention include those having hydroxyl functionalities of about 1.5 to about 6, preferably from about 2 to about 3, and molecular weights of about 192 to about 10,000, preferably from about 400 to about 6,000, to yield a urethane prepolymer having an NCO content of from about 8 to about 28%, preferably about 12 to about 26%. Suitable polyester polyols suitable as isocyanate-reactive compounds (II) for this aspect of the present invention include those having hydroxyl functionalities of about 1.8 to about 2, preferably about 2, and molecular weights of about 200 to about 3,000, preferably from about 500 to about 2,000, to yield a urethane prepolymer having an NCO content of from about 8 to about 28%, preferably about 20 to about 26%. Suitable diols to be used as isocyanate-reactive compounds (II) for forming urethane prepolymers of the allophanate modified, partially trimerized MDI include, for example, 1,3-butanediol, propylene glycol, 2,2,4-trimethyl-1,3-pentanediol, 2-methyl-1,3-propanediol, dipropylene glycol, tripropylene glycol, diethylene glycol and triethylene glycol. Preferred diols are 1,3-butanediol, propylene glycol, dipropylene glycol and tripropylene glycol.

In the process of preparing prepolymers of the stable-liquid, allophanate-modified, partially trimerized diphenylmethane diisocyanates, the stable-liquid, allophanate-modified, partially trimerized diphenylmethane diisocyanates may be prepared directly as above with the allophanate and trimer being formed simultaneously; or by forming the allophanate first, and then the trimer; or these may be prepared from blends of a separately prepared allophanate-modified diphenylmethane diisocyanate, and a separately prepared partially trimerized diphenylmethane diisocyanate.

The process of preparing the urethane-prepolymers of the stable-liquid, allophanate-modified, partially trimerized diphenylmethane diisocyanates of the present invention is typically performed by adding the suitable isocyanate reactive compound to the allophanate modified, partially trimerized MDI, while stirring, under a dry nitrogen pad. The reaction mixture is held at a temperature between 40 and 80° C., preferably 55 to 65° C., for about 1 to 4 hours. When the theoretical NCO group content is reached, the reaction mixture is cooled to about 25° C. for storage.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively.

### EXAMPLES

The following processes are suitable for the preparation of the allophanate modified MDI trimers of the present invention. There are at least three (3) different processes by which the products of the invention can be prepared. Three (3) of these processes are described below. However, only the processes labeled as Process 2 and Process 3 below were used in the working examples of this application.

Process 1: (Preparation of the Trimer and Allophanate Simultaneously.)

The MDI and an organic compound containing at least one hydroxyl group were added to a reactor. When the initial urethane reaction was complete, a trimer catalyst, and optionally, an allophanate catalyst, were added. The reaction mixture was heated at about 70 to 120° C. until the desired NCO content was reached. Then, an acidic stopper was added to neutralize the catalyst and the reaction mixture was then cooled to 25° C. for storage. Alternately, the catalyst can be added to the MDI in the reactor before adding the organic compound containing at least one hydroxyl group.

Process 2: (Preparation of the Allophanate First, then the Trimer.)

The MDI and an organic compound containing at least one hydroxyl group were added to a reactor. When the initial urethane reaction was complete, an allophanate catalyst was added. The reaction mixture was heated to about 70 to 120° C. until the allophanate reaction was complete, or for about 60 minutes. A trimer catalyst was then added, and the reaction mixture was held at about 70 to 120° C. until the desired NCO content was reached. Then, an acidic stopper was added to neutralize the catalysts, and the reaction mixture was then cooled to 25° C. for storage. Alternately, the allophanate catalyst can be added to the MDI before adding the organic compound containing at least one hydroxyl group.

Process 3: (Preparation of the Allophanate and Trimer Separately, and then Blending Together.)

A) The MDI and an organic compound containing at least one hydroxyl group were added to a reactor. When the initial urethane reaction was complete, an allophanate catalyst was added. The reaction mixture was heated at about 70 to 120° C. until the allophanate reaction was complete, or for about 60 minutes. Then, an acidic stopper was added to neutralize the catalyst and the reaction mixture was then stored at between 25 and 60° C. Alternately, the catalyst can be added to the MDI before adding the organic compound containing at least one hydroxyl group.

B) MDI was added to a reactor at about 40° C. To the MDI, a trimer catalyst was added, followed by heating at about 70 to 120° until the desired NCO content was reached. Then, an acidic stopper was added to neutralize the catalyst. The stopped reaction mixture, while being held at a temperature between 60 and 100° C., was blended with the product of A) above in the desired ratio, and then cooled to 250 for storage.

The following materials were used in the working examples to demonstrate the stable, liquid, partially trimerized and allophanatized MDI.
MDI-1: an isomeric mixture of diphenylmethane diisocyanate having an NCO content of about 33.6%, and comprising about 98.4% by weight of 4,4′-diphenylmethane diisocyanate and about 1.6% by weight of 2,4′-diphenylmethane diisocyanate.
MDI-2: an isomeric mixture of diphenylmethane diisocyanate having an NCO content of about 33.6%, and comprising about 45.8% by weight of 4,4′-MDI, about 52.8% by weight 2,4′-MDI and about 1.4% by weight of 2,2′-MDI.
Alcohol A: Isobutyl alcohol
Catalyst A: Methylene-bis(3,3′,5,5′,-tetra-dimethylaminomethyl-2,2′-phenol)
Catalyst B: Zinc Acetylacetonate
Acidic Stopper: Benzoyl Chloride

### Example 1

120 parts of MDI-1 and 80 parts of MDI-2 were charged to a stirred reactor and held at 50° C. To this was added 8 parts alcohol A and 0.02 part catalyst B. The mixture was held at 90° C. for about 30 minutes followed by the addition of 0.042 part catalyst A. After about an additional 1.5 hours at 90° C., 0.015 part benzoyl chloride was added and the reaction mixture was cooled to 25° C. The clear, liquid product had an NCO content of 26.1% and a viscosity at 25° C. of 190 mPa·s.

The examples listed in Table 1 were prepared according to Example 1. Examples 2-17 resulted in clear liquid products.

TABLE 1
(Examples prepared according to Example 1)

| | Reaction Mixture, | | | | Acidic Stopper, | | Visc. at 25° C., |
|---|---|---|---|---|---|---|---|
| Example # | pbw | | Catalyst, ppm | | ppm | % NCO | mPa · s |
| 2 | 120 | MDI-1 | 95 | Catalyst B | 70 | 24.1 | 850 |
| | 80 | MDI-2 | 227 | Catalyst A | | | |
| | 10.9 | Alcohol A | | | | | |
| 3 | 226 | MDI-1 | 72 | Catalyst B | 70 | 26.2 | 206 |
| | 56.5 | MDI-2 | 146 | Catalyst A | | | |
| | 11.3 | Alcohol A | | | | | |
| 4 | 140 | MDI-1 | 75 | Catalyst B | 70 | 24.2 | 640 |
| | 60 | MDI-2 | 194 | Catalyst A | | | |
| | 10.9 | Alcohol A | | | | | |
| 5 | 30 | MDI-1 | 100 | Catalyst B | 150 | 21.4 | 15300 |
| | 70 | MDI-2 | 300 | Catalyst A | | | |
| | 4.6 | Alcohol A | | | | | |
| 6 | 80 | MDI-1 | 100 | Catalyst B | 150 | 22.5 | 4600 |
| | 120 | MDI-2 | 300 | Catalyst A | | | |
| | 9.2 | Alcohol A | | | | | |
| 7 | 100 | MDI-1 | 100 | Catalyst B | 150 | 22.4 | 4000 |
| | 100 | MDI-2 | 300 | Catalyst A | | | |
| | 9.2 | Alcohol A | | | | | |
| 8 | 100 | MDI-1 | 100 | Catalyst B | 150 | 23.3 | 1910 |
| | 100 | MDI-2 | 300 | Catalyst A | | | |
| | 9.2 | Alcohol A | | | | | |
| 9 | 100 | MDI-1 | 100 | Catalyst B | 150 | 23.7 | 1800 |
| | 100 | MDI-2 | 300 | Catalyst A | | | |
| | 8.0 | Alcohol A | | | | | |
| 10 | 60 | MDI-1 | 100 | cat. B | 150 | 22.9 | 2610 |
| | 140 | MDI-2 | 300 | cat. A | | | |
| | 8.0 | Alcohol A | | | | | |
| 11 | 60 | MDI-1 | 100 | cat. B | 150 | 22.1 | 14300 |
| | 140 | MDI-2 | 300 | cat. A | | | |
| | 8.0 | Alcohol A | | | | | |
| 12 | 60 | MDI-1 | 100 | cat. B | 150 | 25.2 | 520 |
| | 140 | MDI-2 | 300 | cat. A | | | |
| | 6.4 | Alcohol A | | | | | |
| 13 | 60 | MDI-1 | 100 | cat. B | 150 | 23.6 | 14300 |
| | 140 | MDI-2 | 300 | cat. A | | | |
| | 6.4 | Alcohol A | | | | | |
| 14 | 60 | MDI-1 | 100 | cat. B | 150 | 26.3 | 260 |
| | 140 | MDI-2 | 300 | cat. A | | | |
| | 5.0 | Alcohol A | | | | | |
| 15 | 60 | MDI-1 | 100 | cat. B | 150 | 25.2 | 760 |
| | 140 | MDI-2 | 300 | cat. A | | | |
| | 5.0 | Alcohol A | | | | | |
| 16 | 60 | MDI-1 | 100 | cat. B | 150 | 24.0 | 4300 |
| | 140 | MDI-2 | 300 | cat. A | | | |
| | 5.0 | Alcohol A | | | | | |
| 17 | 60 | MDI-1 | 100 | cat. B | 150 | 25.8 | 380 |
| | 140 | MDI-2 | 300 | cat. A | | | |
| | 3.6 | Alcohol A | | | | | |

The following comparative examples show that greater than 38% by weight of 2,4′-MDI is required to obtain a storage stable liquid trimer modified MDI.

### Example 18

To a stirred reactor was added 100 parts MDI-1 and 100 parts MDI-2. The mixture was heated to 90° C. and 250 ppm catalyst A added. The reaction mixture was held at 90° C. for about 3 hours followed by the addition of 100 ppm benzoyl chloride. The reaction mixture was cooled to 25° C. The partially trimerized MDI had an NCO content of 30.6%. On storage at 25° C., the product became turbid with about 15% solids. The experiment was repeated to 29.6% NCO with the same results.

### Example 19

Example 18 was repeated with 60 parts MDI-1 and 140 parts MDI-2 to an NCO content of 30.6%. The product was turbid with 10% solids. This was repeated to 29.7% NCO with the same results.

The following example was prepared according to Process 3 to yield stable liquid, partially trimerized, allophanate-modified MDI.

### Example 20

A) To a stirred reactor was added 100 parts of MDI-1 and 9.4 parts of Alcohol A. After about 15 minutes, the initial urethane reaction was complete. The reaction mixture was then heated under a nitrogen blanket to 90° C. and 100 ppm of Catalyst B were added. The reaction mixture was held at 90° C. for 90 minutes, followed by the addition of 150 ppm benzoyl chloride. The reaction mixture was then cooled to 25° C. The clear, liquid, allophanate-modified MDI product had an NCO content of 21.0%.

B) To a stirred reactor was added 30 parts of MDI-1 and 70 parts of MDI-2. To this mixture, at 90° C. under a nitrogen blanket, 300 ppm Catalyst A were added. After about 3 hours at 90° C., 100 ppm benzoyl chloride are added and the reaction mixture is cooled to about 60° C. The clear, liquid, partially trimerized MDI product had an NCO content of 25.9%.

A blend according to Process 3 was prepared by blending 38% by weight of the product of A) with 62% by weight of the product of B) to yield a final blended product with an NCO content of about 24.0% and a viscosity at 25° C. of about 2526 mPa·s.

The product prepared in B) above, a partially trimerized MDI, when cooled to 25° C. became turbid with solids.

The following materials were used in the preparation of the prepolymers of the allophanate-modified, partially trimerized MDI.
ISO A: the allophanate-modified partially trimerized MDI of Example 15, characterized by an NCO content of about 25.2% and a viscosity at 25° C. of about 760 mPa·s.
ISO B: the allophanate-modified, partially trimerized MDI of Example 17, characterized by an NCO content of about 25.9% and a viscosity at 25° C. of about 380 mPa·s.
XB: 1,3-butanediol
Polyether Polyol A: a propylene glycol/propylene oxide adduct having a molecular weight of about 1,000 and a functionality of about 2.
Polyether Polyol B: a propylene glycol/propylene oxide adduct having a molecular weight of about 2000 and a functionality of about 2.

### Example 21

100 parts of ISO A were charged to a reactor with a stirrer and nitrogen blanket. The contents of the reactor were heated to 60° C. with stirring. 2.8 parts of XB were then added and the reaction mixture was held at 60° C. for 2 hours, and then cooled to 25° C. The clear liquid prepolymer had an NCO content of about 22.0% and a viscosity at 250 of about 86,000 mPa·s.

### Example 22

Using the procedure as described above in Example 21, 100 parts of ISO A and 17.2 parts of Polyether Polyol A were reacted to yield a clear, liquid prepolymer having an NCO content of about 20.3% and a viscosity at 25° C. of about 11,200 mPa·s.

### Example 23

Using the procedure as described above in Example 21,100 parts of ISO A and 20.1 parts of Polyether Polyol B were reacted to yield a clear, liquid prepolymer having an NCO content of about 20.2% and a viscosity at 25° C. of about 8200 mPa·s.

### Example 24

Using the procedure as described above in Example 21, 100 parts of ISO B and 16.7 parts of Polyether Polyol A were reacted to yield a clear, liquid prepolymer having an NCO content of about 21.0% and a viscosity at 25° C. of about 2080 mPa·s.

### Example 25

Using the procedure as described above in Example 21,100 parts of ISO B and 2.85 parts of XB were reacted to yield a clear, liquid prepolymer having an NCO content of about 22.6% and a viscosity at 25° C. of about 22,500 mPa·s.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A stable liquid, allophanate-modified, partially trimerized diphenylmethane diisocyanate having an NCO group content of from 15 to 30% and comprising the reaction product of:
a)(1) a diphenylmethane diisocyanate comprising:
(i) from 10 to 40% by weight of 2,4′-diphenylmethane diisocyanate,
(ii) from 0 to 6% by weight of 2,2′-diphenylmethane diisocyanate,
and
(iii) from 54 to 90% by weight of 4,4′-diphenylmethane diisocyanate,
wherein the %'s by weight of a)(1)(i), a)(1)(ii) and a)(1)(iii) total 100% by weight of a)(1);
and
b) an organic compound containing at least one hydroxyl group,
in the presence of a catalytic amount of
c) at least one catalyst selected from the group consisting of (1) one or more trimer catalysts, (2) one or more allophanate catalysts, (3) an allophanate-trimer catalyst system and (4) mixtures thereof;
wherein component b) is present in a quantity such that there are from about 0.01 to about 0.25 equivalent hydroxyl groups per equivalent of isocyanate of the MDI present, at least about 50% of the urethane groups are converted to allophanate groups by c) said catalyst or catalyst system, and a catalyst stopper is added once the desired NCO group content is attained.

2. The stable liquid, allophanate-modified, partially trimerized diphenylmethane diisocyanate of claim 1, wherein the NCO group content is from 20 to 28%.

3. The stable liquid, allophanate-modified, partially trimerized diphenylmethane diisocyanate of claim 1, wherein a)(1) said diphenyl-methane diisocyanate comprises (i) from 20 to 35% by weight of the 2,4′-isomer, (ii) from 0 to 2% by weight of the 2,2′-isomer, and (iii) from 63 to 80% by weight of the 4,4′-isomer, with the %'s by weight of a)(1)(i), a)(1)(ii) and a)(1)(iii) totaling 100% by weight of a)(1).

4. The stable liquid, allophanate-modified, partially trimerized diphenylmethane diisocyanate of claim 1, wherein component b) is present in an amount such that there are from about 0.01 to 0.20 equivalent hydroxyl groups per equivalent of isocyanate of the diphenylmethane diisocyanate present.

5. The stable liquid, allophanate-modified, partially trimerized diphenylmethane diisocyanate of claim 1, wherein at least about 70% of the urethane groups are converted to allophanate groups by c) said catalyst.

6. The stable liquid, allophanate-modified, partially trimerized diphenylmethane diisocyanate of claim 1, wherein the allophanate groups and the trimer groups were formed simultaneously.

7. The stable liquid, allophanate-modified, partially trimerized diphenylmethane diisocyanate of claim 1, wherein the allophanate groups were formed first, and then the trimer groups were formed.

8. The stable liquid, allophanate-modified, partially trimerized diphenylmethane diisocyanate of claim 1, wherein b) said organic compound has a molecular weight of from about 32 to about 6,000 and contains from about 1 to about 4 hydroxyl groups.

9. The stable liquid, allophanate-modified, partially trimerized diphenylmethane diisocyanate of claim 1, wherein b) comprises 2-propanol or isobutyl alcohol.

10. A process for the preparation of a stable liquid, allophanate-modified, partially trimerized diphenylmethane diisocyanate having an NCO group content of from 15 to 30%, comprising:
(1) heating
a)(1) diphenylmethane diisocyanate comprising:
(i) from 10 to 40% by weight of 2,4′-diphenylmethane diisocyanate,
(ii) from 0 to 6% by weight of 2,2′-diphenylmethane diisocyanate,
and
(iii) from 54 to 90% by weight of 4,4′-diphenylmethane diisocyanate,
wherein the %'s by weight of a)(1)(i), a)(1)(ii) and a)(1)(iii) total 100% by weight of a)(1);
and
b) an organic compound containing at least one hydroxyl group, to a temperature of about 70 to 120° C. for a time period of about 1 to about 6 hrs., in the presence of a catalytic amount of:
c) at least one catalyst selected from the group consisting of (1) one or more trimer catalysts, (2) one or more allophanate catalysts, (3) an allophanate-trimer catalysts system and (4) mixtures thereof;
wherein the quantity of b) is such that there are from about 0.01 to about 0.25 equivalent hydroxyl groups per equivalent of isocyanate of the MDI present, and at least about 50% of the urethane groups are converted to allophanate groups by c) said catalyst(s),
and
(2) adding a catalyst stopper once the desired NCO group content of the reaction mixture in (1) is attained to neutralize the catalyst in the reaction mixture.

11. The process of claim 10, wherein the NCO group content is from 20 to 28%.

12. The process of claim 10, wherein a)(1) said diphenylmethane diisocyanate comprises (i) from 20 to 35% by weight of the 2,4′-isomer, (ii) from 0 to 2% by weight of the 2,2′-isomer, and (iii) from 63 to 80% by weight of the 4,4′-isomer, with the %'s by weight of a)(1)(i), a)(1)(ii) and a)(1)(iii) totaling 100% by weight of a)(1).

13. The process of claim 10, wherein component b) is present in an amount such that there are from about 0.01 to 0.20 equivalent hydroxyl groups per equivalent of isocyanate of the diphenylmethane diisocyanate present.

14. The process of claim 10, wherein at least about 70% of the urethane groups are converted to allophanate groups by c) said catalyst.

15. The process of claim 10, wherein c) the catalyst is selected such that the allophanate groups and the trimer groups form simultaneously.

16. The process of claim 10, wherein c) the catalyst is selected such that the allophanate groups are formed first, and then another suitable catalyst c) is added such that the trimer groups are formed.

17. The process of claim 10, wherein b) said organic compound has a molecular weight of from about 32 to about 6,000 and contains from about 1 to about 4 hydroxyl groups.

18. The process of claim 10, wherein b) comprises 2-propanol or isobutyl alcohol.

19. A stable liquid allophanate-modified, partially trimerized diphenylmethane diisocyanate having an NCO group content of from 15 to 30% and comprising:
(A) from 20 to 65% by weight, based on 100% by weight of (A) and (B), of an allophanate-modified diphenylmethane diisocyanate having an NCO group content of from about 16 to about 29%, and comprising the reaction product of:
a)(2) a diphenylmethane diisocyanate comprising
(i) from 0 to 60% by weight of 2,4′-diphenylmethane diisocyanate,
(ii) from 0 to 6% by weight of 2,2′-diphenylmethane diisocyanate,
and
(iii) from 34 to 100% by weight of 4,4′-diphenylmethane diisocyanate,
wherein the %'s by weight of a)(2)(i), a)(2)(ii) and a)(2)(iii) total 100% by weight of a)(2),
and
b) an organic compound containing at least one hydroxyl group,
in the presence of
c)(2) one or more allophanate catalyst,
wherein component b) is present in a quantity such that there are from about 0.05 to about 0.25 equivalent hydroxyl groups per equivalent of isocyanate of the MDI present, at least about 50% of the urethane groups are converted to allophanate groups by c)(2), and a catalyst stopper is added once the desired NCO group content of the allophanate-modified MDI is attained;
and
(B) from 35 to 80% by weight, based on 100% by weight of (A) and (B), of a partially trimerized diphenylmethane diisocyanate having an NCO group content of from about 20 to about 31%, and comprising the trimerization product of:
a)(3) a diphenylmethane diisocyanate comprising
(i) from 10 to 60% by weight of 2,4′-diphenylmethane diisocyanate,
(ii) from 0 to 6% by weight of 2,2′-diphenylmethane diisocyanate,
and
(iii) from 34 to 90% by weight of 4,4′-diphenylmethane diisocyanate,
wherein the %'s by weight of a)(3)(i), a)(3)(ii) and a)(3)(iii) total 100% by weight of a)(3),
in the presence of
c) at least one catalyst selected from the group consisting of (1) one or more trimer catalysts, (3) a trimer-allophanate catalyst system and (4) mixtures thereof;
wherein the trimer content is at least about 10 to about 80%, based on 100% by weight of component (B), and a catalyst stopper is added once the desired NCO group content of the trimer modified MDI is attained.

20. The blend of claim 19 having an NCO group content of 20 to 28%, and comprising:
(A) from 30 to 60% by weight, based on 100% by weight of (A) and (B), of an allophanate-modified diphenylmethane diisocyanate having an NCO group content of about 20 to about 28%,
and
(B) from 40 to 70% by weight, based on 100% by weight of (A) and (B), of partially trimerized diphenylmethane diisocyanate having an NCO group content of about 22 to about 29%

21. The blend of claim 19, wherein:
(A) said allophanate-modified diphenylmethane diisocyanate comprises the reaction product of:
a)(2) a diphenylmethane diisocyanate comprising:
(i) from 10 to 50% by weight of 2,4′-diphenylmethane diisocyanate,
(ii) from 0 to 4% by weight of 2,2′-diphenylmethane diisocyanate,
and
(iii) from 50 to 90% by weight of 4,4′-diphenylmethane diisocyanate,
with the %'s by weight of a)(2)(i), a)(2)(ii) and a)(2)(iii) totaling 100% by weight of a)(2);
b) an organic compound having a molecular weight of from about 32 to about 6,000 and containing from about 1 to about 4 hydroxyl groups;
in the presence of
c) one or more allophanate catalyst.

22. The blend of claim 19, wherein in (A) the allophanate-modified diphenylmethane diisocyanate, the quantity of b) is such that there are from about 0.10 to 0.20 equivalent hydroxyl groups per equivalent of isocyanate of the MDI present, and at least about 70% of the urethane groups are converted to allophanate groups.

23. The blend of claim 19, wherein (B) said trimerized diphenylmethane diisocyanate comprises the trimerization product of
a)(3) a diphenylmethane diisocyanate comprising the reaction product of:
(i) from 20 to 40% by weight of 2,4′-diphenylmethane diisocyanate,
(ii) from 0 to 2% by weight of 2,2′-diphenylmethane diisocyanate,
and
(iii) from 60 to 80% by weight of 4,4′-diphenylmethane diisocyanate,
wherein the %'s by weight of a)(3)(i), a)(3)(ii) and a)(3)(iii) total 100% by weight of a)(3);
in the presence of:
c) at least one catalyst selected from the group consisting of (1) one or more trimer catalysts, (3) a trimer-allophanate catalyst system and (4) mixtures thereof;
wherein the trimer content is at least about 25 to about 60%, based on 100% by weight of component (B).

24. The blend of claim 19, wherein b) said organic compound has a molecular weight of from about 32 to about 6,000 and contains from about 1 to about 4 hydroxyl groups.

25. The blend of claim 19, wherein b) comprises 2-propanol or isobutyl alcohol.

26. A process for the preparation of a stable liquid allophanate-modified, partially trimerized diphenylmethane diisocyanate having an NCO group content of from 15 to 30% and comprising
(1) blending
(A) from 20 to 65% by weight, based on 100% by weight of (A) and (B), of an allophanate-modified diphenylmethane diisocyanate having an NCO group content of from about 16 to about 29, and comprising the reaction product of
a)(2) a diphenylmethane diisocyanate comprising
(i) from 0 to 60% by weight of 2,4′-diphenylmethane diisocyanate,
(ii) from 0 to 6% by weight of 2,2′-diphenylmethane diisocyanate,
and
(iii) from 34 to 100% by weight of 4,4′-diphenylmethane diisocyanate,
wherein the %'s by weight of a)(2)(i), a)(2)(ii) and a)(2)(iii) total 100% by weight of a)(2),
with
b) an organic compound containing at least one hydroxyl group,
in the presence of:
c)(2) one or more allophanate catalyst,
wherein component b) is present in a quantity such that there are from about 0.05 to about 0.25 equivalent hydroxyl groups per equivalent of isocyanate of the MDI present, at least about, at least about 50% of the urethane groups are converted to allophanate groups by c)(2) and a catalyst stopper is added once the desired NCO group content of the allophanate-modified MDI is attained;
with
(B) from 35 to 80% by weight, based on 100% by weight of (A) and (B), of an at least partially trimerized diphenylmethane diisocyanate having an NCO group content of from about 20 to about 31%, and comprising the trimerization product of
a)(3) a diphenylmethane diisocyanate comprising
(i) from 10 to 60% by weight of 2,4′-diphenylmethane diisocyanate,
(ii) from 0 to 6% by weight of 2,2′-diphenylmethane diisocyanate,
and
(iii) from 34 to 90% by weight of 4,4′-diphenylmethane diisocyanate,
wherein the %'s by weight of a)(3)(i), a)(3)(ii) and a)(3)(iii) total 100% by weight of a)(3),
formed in the presence of:
c) at least one catalyst selected from the group consisting of (1) one or more trimer catalyst, (3) a trimer-allophanate catalyst system and (4) mixtures thereof;
wherein the trimer content is at least about 10 to about 80%, based on 100% by weight of component (B), and a catalyst stopper is added once the desired NCO group content is achieved,
and
(2) cooling the blend to ambient temperature.

27. The process of claim 26, having an NCO group content of 20 to 28%, and comprising:
(A) from 30 to 60% by weight, based on 100% by weight of (A) and (B), of an allophanate-modified diphenylmethane diisocyanate having an NCO group content of about 20 to about 28%,
and
(B) from 40 to 70% by weight, based on 100% by weight of (A) and (B), of partially trimerized diphenylmethane diisocyanate having an NCO group content of about 22 to about 29%

28. The process of claim 26, wherein:
(A) said allophanate-modified diphenylmethane diisocyanate comprises the reaction product of:
a)(2) a diphenylmethane diisocyanate comprising:
(i) from 10 to 50% by weight of 2,4′-diphenylmethane diisocyanate,
(ii) from 0 to 4% by weight of 2,2′-diphenylmethane diisocyanate,
and
(iii) from 50 to 90% by weight of 4,4′-diphenylmethane diisocyanate,
with the %'s by weight of a)(2)(i), a)(2)(ii) and a)(2)(iii) totaling 100% by weight of a)(2);
b) an organic compound having a molecular weight of from about 32 to about 6,000 and containing from about 1 to about 4 hydroxyl groups;
in the presence of
c) one or more allophanate catalyst.

29. The process of claim 26, wherein in (A) the allophanate-modified diphenylmethane diisocyanate, the quantity of b) is such that there are from about 0.10 to 0.20 equivalent hydroxyl groups per equivalent of isocyanate of the MDI present, and at least about 70% of the urethane groups are converted to allophanate groups.

30. The process of claim 26, wherein (B) said trimerized diphenylmethane diisocyanate comprises the trimerization product of
a)(3) a diphenylmethane diisocyanate comprising the reaction product of:
(i) from 20 to 40% by weight of 2,4′-diphenylmethane diisocyanate,
(ii) from 0 to 2% by weight of 2,2′-diphenylmethane diisocyanate,
and
(iii) from 60 to 80% by weight of 4,4′-diphenylmethane diisocyanate,
wherein the %'s by weight of a)(3)(i), a)(3)(ii) and a)(3)(iii) total 100% by weight of a)(3);
in the presence of:
c) at least one catalyst selected from the group consisting of (1) one or more trimer catalysts, (3) a trimer-allophanate catalyst system and (4) mixtures thereof;
wherein the trimer content is at least about 25 to about 60%, based on 100% by weight of component (B).

31. The process of claim 26, wherein b) said organic compound has a molecular weight of from about 32 to about 6,000 and contains from about 1 to about 4 hydroxyl groups.

32. The process of claim 26, wherein b) comprises 2-propanol or isobutyl alcohol.

33. A storage stable, liquid, urethane prepolymer of an allophanate modified, partially trimerized diphenylmethane diisocyanate having an NCO group content of 8 to 28%, and comprising the reaction product of:
(I) a storage stable, liquid, allophanate-modified, partially trimerized diphenylmethane diisocyanate having an NCO group content of from 15 to 30% and comprising the reaction product of:
a)(1) a diphenylmethane diisocyanate comprising:
(i) from 10 to 40% by weight of 2,4′-diphenylmethane diisocyanate,
(ii) from 0 to 6% by weight of 2,2′-diphenylmethane diisocyanate,
and
(iii) from 54 to 90% by weight of 4,4′-diphenylmethane diisocyanate,
wherein the %'s by weight of a)(1)(i), a)(1)(ii) and a)(1)(iii) total 100% y weight of a)(1);
and
b) an organic compound containing at least one hydroxyl group,
in the presence of a catalytic amount of
c) at least one catalyst selected from the group consisting of (1) one or more trimer catalysts, (2) one or more allophanate catalysts, (3) an allophanate-trimer catalyst system and (4) mixtures thereof;
wherein component b) is present in a quantity such that there are from about 0.01 to about 0.25 equivalent hydroxyl groups per equivalent of isocyanate of the MDI present, at least about 50% of the urethane groups are converted to allophanate groups by c) said catalyst or catalyst system, and a catalyst stopper is added once the desired NCO group content is attained;
and
(II) an isocyanate-reactive component containing from about 1.5 to about 6 hydroxyl groups and having a molecular weight of from about 76 to about 10,000.

34. The storage stable, liquid, urethane prepolymer of claim 33, wherein the NCO group content is from about 12 to about 26%.

35. The storage stable, liquid urethane prepolymer of claim 33, wherein (II) said isocyanate-reactive component contains from 2 to 6 hydroxyl groups and has a molecular weight of about 90 to about 6,000.

36. A process for the preparation of a storage-stable, liquid, urethane prepolymer of an allophanate-modified, partially trimerized diphenylmethane diisocyanate having an NCO group content of from about 8 to about 28, comprising:
(1) reacting:
(I) a storage stable, liquid, allophanate-modified, partially trimerized diphenylmethane diisocyanate having an NCO group content of from 15 to 30% and comprising the reaction product of:
a)(1) a diphenylmethane diisocyanate comprising:
(i) from 10 to 40% by weight of 2,4′-diphenylmethane diisocyanate,
(ii) from 0 to 6% by weight of 2,2′-diphenylmethane diisocyanate,
and
(iii) from 54 to 90% by weight of 4,4′-diphenylmethane diisocyanate,
wherein the %'s by weight of a)(1)(i), a)(1)(ii) and a)(1)(iii) total 100% y weight of a)(1);
and
b) an organic compound containing at least one hydroxyl group,
in the presence of a catalytic amount of
c) at least one catalyst selected from the group consisting of (1 one or more trimer catalysts, (2) one or more allophanate catalysts, (3) an allophanate-trimer catalyst system and (4) mixtures thereof;
wherein component b) is present in a quantity such that there are from about 0.01 to about 0.25 equivalent hydroxyl groups per equivalent of isocyanate of the MDI present, at least about 50% of the urethane groups are converted to allophanate groups by c) said catalyst or catalyst system, and a catalyst stopper is added once the desired NCO group content is attained;
with
(II) an isocyanate-reactive component containing from about 1.5 to about 6 hydroxyl groups and having a molecular weight of from about 76 to about 10,000,
at a temperature of from 40 to 80° C. for 1 to 6 hours.

37. The process of claim 36, wherein the NCO group content is from about 12 to about 26%.

38. The process of claim 36, wherein (II) said isocyanate-reactive component contains from 2 to 6 hydroxyl groups and has a molecular weight of about 90 to about 6,000.

39. A storage stable, liquid, urethane prepolymer of an allophanate modified, partially trimerized diphenylmethane diisocyanate having an NCO group content of 8 to 28%, and comprising the reaction product of:
(III) the storage-stable, liquid, allophanate-modified, partially trimerized diphenylmethane diisocyanate of claim 19,
and
(II) an isocyanate-reactive component containing from about 1.5 to about 6 hydroxyl groups and having a molecular weight of from about 76 to about 10,000.

40. The prepolymer of claim 39, wherein the NCO group content is from about 12 to about 26%.

41. The prepolymer of claim 39, wherein (II) said isocyanate-reactive component contains from 2 to 6 hydroxyl groups and has a molecular weight of about 90 to about 6,000.

42. A process for the preparation of a storage-stable, liquid, urethane prepolymer of an allophanate-modified, partially trimerized diphenylmethane diisocyanate having an NCO group content of from about 8 to about 28%, comprising:
(1) reacting:
(III) the storage-stable, liquid, allophanate-modified, partially trimerized diphenylmethane diisocyanate of claim 19,
and
(I) an isocyanate-reactive component containing from about 1.5 to about 6 hydroxyl groups and having a molecular weight of from about 76 to about 10,000,
at a temperature of from 40 to 80° C. for 1 to 6 hours.

43. The process of claim 42, wherein the NCO group content is from about 12 to about 26%.

44. The process of claim 42, wherein (II) said isocyanate-reactive component contains from 2 to 6 hydroxyl groups and has a molecular weight of about 90 to about 6,000.
